(19) United States
(12) Patent Application Publication
(10) Pub. No.: US 2006/0265896 A1
(43) Pub. Date: Nov. 30, 2006

(54) Digital growth chart

(75) Inventor: Jordan Steven Kavana, Miami, FL (US)

Correspondence Address: MR. JORDAN KAVANA;K GROUP INDUSTRIES, 4770 BISCAYNE BLVD, SUITE 980, MIAMI, FL, 33137, US

(73) Assignee: K Group Industries (Far East) Ltd., Miami, FL (US)

(21) Appl. No.: 11/139,182

(22) Filed: May 27, 2005

(51) Int. Cl. G01B 5/00

(52) U.S. Cl. 33/832

(57) ABSTRACT

A digital growth chart that is affixed to a wall or other elevated surface at a specified height. A measuring element may then be extended from the device and pulled to a point such that it is at the same height as the individual being measured. Once the measuring element has been extended to the appropriate height, the measurement may be taken and recorded by the device, either automatically or through manual activation of the device. The device may include systems for announcing and/or displaying the height. In addition, the device may include the ability to store records for a plurality of individuals.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates to systems for measuring height. More specifically, the present invention relates to digital systems for measuring height.

### BACKGROUND OF THE INVENTION

Traditional systems for measuring the height of an adult and/or a child have generally been simple devices using a writing instrument, a wall, and possibly a chart. In these systems, such as those designed for home use, wall-mounted charts with rulings may be employed that require that a flat item be placed on the top of the person's head and the chart or wall marked. Making sure that the mark is correct is essential and can be a difficult achievement. In addition, the head and hair often make the wall ruling hard to see or to mark. Lastly, these systems result in marks or charts that can be destructive to the walls and/or lost over time.

More sophisticated devices, such as those found in medical facilities, have also been used. These devices are usually mounted on a weight scale and include an indexed, vertically telescoping rod, equipped with an attachment that is hinged at a right angle to provide contact with a person's head. While these devices are less troublesome in providing a substantial degree of accuracy, they are not well suited to use in the home. They are also relatively expensive and heavy and must either be stored when not in use or allowed to occupy valuable living space.

Other prior art devices use a retractable and extendable measuring tape that differs from conventional tapes in the direction of its numbering sequence. Instead of beginning with the lowest numerical indication of measurement at the outer, extendable end of the tape, with incremental increases toward the end secured in the case or holder, the tape indicates the maximum measurement capacity at its outer, extendable end and has incremental decreases toward the end secured on the holder, with a final indication of zero. However, these devices require that a user determine the actual measurement, which results in an unnecessary step that may also result in incorrect measurements due to judgment errors.

Accordingly, it would be beneficial to provide a measuring device that was simpler to use than prior art devices. It would also be beneficial to provide a measuring device that was more accurate than prior art devices.

### SUMMARY OF THE INVENTION

The present invention provides a digital growth chart. The digital growth chart device may be affixed to a wall or other elevated surface at a selected height. A measuring element is then extended from the device and is extended to a point such that the end of the measuring element is located at the top of the individual being measured. Once the measuring element has been extended to the appropriate height, the measurement may be taken and recorded by the device, either automatically or through manual activation of the device. The device may include systems for announcing and/or displaying the height. In addition, the device may include the ability to store records for a plurality of individuals.

These and other embodiments are described in more detail below.

### BRIEF DESCRIPTION OF THE DRAWINGS

Other objects, features and advantages of the present invention will become apparent upon reading the following detailed description, while referring to the attached drawings, in which:

FIG. 1 shows a perspective view of a digital growth chart according to one embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

The present invention provides a digital growth chart. In one embodiment of the present invention, a digital growth chart device is affixed to a wall or other elevated surface at a specified height. A measuring element may then be extended from the device and is pulled to a point such that it is at the same height as the individual being measured. Once the measuring element has been extended to the appropriate height, the measurement may be taken and recorded by the device, either automatically or through manual activation of the device. The device may include systems for announcing and/or displaying the height. In addition, the device may include the ability to store records for a plurality of individuals.

Accordingly, in one embodiment of the present invention, the measuring devices include electronic components for measuring and/or recording the height of an individual. These electronic components may include a display, a microprocessor, an extendible measuring element, and/or a system capable of automatically determining a person's height based upon an amount of the measuring element that is extended from the device.

In one aspect, the devices of the present invention include a microprocessor in conjunction with a system capable of automatically determining a person's height based upon an amount of the measuring element that is extended from the device. In one embodiment, the system capable of automatically determining a person's height includes a sensor located on the holder for the measuring element. The sensor is capable of determining the length of the measuring element that is extended from the device as the measuring element based upon the number of rotations of the holder. In this embodiment, the measuring element is located on a holder that rotates and, based on the number of rotations, the length of the measuring element that has been extended can be calculated.

As such, in this embodiment, an electro mechanical design may be used. This embodiment includes a holder for holding the measuring element, the measuring element, and a means for determining the amount of measuring element that has been extended. The measuring element may be fed out from the holder. In one embodiment, the means for determining the amount of measuring element that has been extended may include a magnet imbedded into the holder and a sensor, which may be attached to the microprocessor. As the measuring element is extended, the holder rotates one turn for each wrap of measuring element on the holder. The sensor may detect the movement of the magnet past the sensor for each rotation. Each wrap of measuring element that is deployed may be counted by the microprocessor, which may calculate the amount of measuring element that is extended using any method that would be known to one of skill in the art, for example a calibrated table of turns-to-length.

In another embodiment, the system capable of automatically determining a person's height includes a series of markings on the measuring element and a sensor for determining the number of markings that have been extended from the device as the measuring element is moved out of the device. In this embodiment, as the measuring element is extended, the sensor marks the number of markings that pass the sensor. Based upon the placement of the markings, the length of the measuring element that has been extended can be calculated. In one embodiment, the markings may lights and the reader may be an optical sensor. In an alternative embodiment, the markings may be magnetic and the reader may be a sensor capable of reading magnetic markers.

In addition to the system capable of automatically determining a person's height, the devices of the present invention may include a display for displaying the measured height of the individual. The display may be a liquid crystal display or any other type of display capable of providing information related to the measurement of a person's height, including the person's names, age, date and/or the actual measurement. In alternative embodiments, no display is provided.

In addition to the display or as an alternative thereto, the electronic components used in the devices of the present invention may include a speaker or other means for audibly announcing the measurement of the individual.

In an alternative embodiment, the electronic components used in the devices of the present invention may also include a data storage unit for storing previous measurements. The data storage unit may be designed to store data on one person or a combination of persons. The data storage may also store data regarding each person, such as age and/or birth date, as well as storing data on the date the measurement was taken and/or the actual measurement. In one embodiment, the data may be stored by recording the voice of a user.

In yet another alternative embodiment, the devices of the present invention may include a mechanism for causing the measurement to be taken. For example, in one embodiment, a button, switch, or related mechanism may be located on the device. Then, after the measuring element has been extended to the top of the person's head, the button, switch, or related mechanism may be actuated to cause the measurement to be taken and/or recorded. In an alternative embodiment, the device may automatically register the recorded height, such as after a period of time after the measuring element has stopped being extracted from the device.

The devices of the present invention also include a measuring element that is withdrawn from the device. In one embodiment, the measuring element may be a cord, rope or related element that may be withdrawn from the device. Alternatively, the measuring element is a flexible tape element that may be made from a material including, but not limited to, metal, plastic, or cloth. In each embodiment, the measuring element may be secured at one end to a holder located within the device. The holder may include, in one embodiment, a self-winding mechanism such that the measuring element will automatically retract itself within the device once the measurement has been taken. Alternatively, the measuring element may be manually retracted into the device by the user, either by rewinding the measuring element or by pushing the measuring element back into the device.

In an alternative embodiment, the measuring element may include a weight or similar item at the end of the measuring element that may be used to keep the measuring element straight and/or to assist in measuring the individual. If a weight is added to an end of the measuring element, then, the length of the weight should be taken into account when determining the placement of the device to ensure proper measurements.

In alternative embodiments, the invention may include a bracket for fixing the device to the wall or other horizontal surface. Alternatively, the device may be affixed directly to the wall or other horizontal surface. The bracket and/or the device may be affixed to the horizontal surface using any known fasteners including, but not limited to, a nail, a screw, a bolt, a hook-and-loop fastener, an adhesive, or a combination thereof.

The device may include an outer housing for holding the measuring element and the electronic components. The housing may be made from plastic, metal or any other suitable material. In an alternative embodiment, the device may include a crank if the measuring element is to be manually rewound and/or a locking mechanism for retaining the measuring element in a retracted position.

The device is affixed at a known height above the floor. A mark or other designation may be made on the floor to indicate where the person to be measured should stand such that the device is able to take an accurate reading. In one embodiment, the height at which the device is placed may be input into the device such that the unit calculates the person's height based upon this initial input height.

The measuring element may be unmarked as the electronic components are designed to calculate a person's height based upon the amount of measuring element retracted from the device. Nevertheless, in select embodiments, the measuring element may also include measurement markings. These markings may be in inches, feet, centimeters, meters, or a combination thereof.

The length of the measuring element may be from about 1 to about 8 feet in length as most individuals fall within this range. In select embodiments, the length if the measuring element is from about 4 to about 6 feet in length. Nevertheless, if the device is used to measure animals, longer measuring elements may be used.

The measuring element may be positioned such that it extends from the bottom of the device. Alternatively, the measuring element may be positioned such that it extends from a side of the device. In either embodiment, the device should be located on the horizontal surface at a height that takes into account whether the measuring element extends from the bottom of the device or one of the sides.

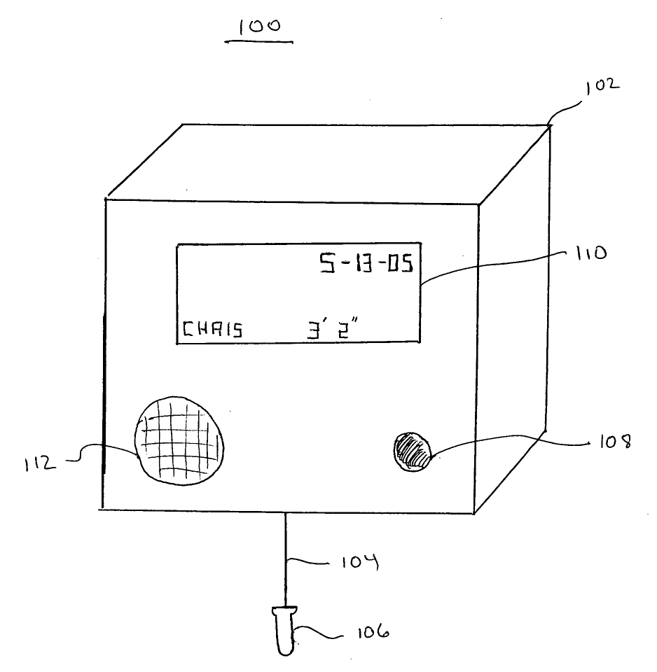

Reference will now be made to FIG. 1 wherein the versatility of the devices of the present invention may be better understood. However, it is to be understood that these embodiments are for example purposes only and are not to be considered to be limiting in any manner of the overall scope of the present invention.

In FIG. 1, the device 100 includes an outer housing 102 from which a measuring element 104 is housed. In this embodiment, the measuring element 104 includes a weight 106 attached to an end thereto for use in measuring an individual. In use, the device 100 is attached to a horizontal surface at a predetermined height. This height may be preselected for a device, or may be programmed into the device 100. To measure an individual, the weight 106 is brought to the top of an individual's head. Once the measuring element 104 has been extended to the selected height, the person's height may then be recorded, either by pressing button 108 or automatically. A display 110 may show the measured height, while speaker 112 may announce the measured height. Once the measurement has been taken and/or recorded, the measuring element 104 may be retracted back into the housing 102.

It is to be understood that while the invention has been described in conjunction with the specific embodiments thereof, as well as the preceding examples, these embodiment and examples are intended to illustrate and not limit the scope of the invention. Other aspects, advantages and modifications within the scope of the invention will be apparent to those skilled in the art to which the invention pertains.

We claim:

1. A digital growth chart comprising:
a measuring element;
a holder for holding the measuring element;
a system for automatically determining a person's height based upon an amount of the measuring element that is extended from the digital growth chart; and
a display for displaying information from the system for automatically determining a person's height.

2. The digital growth chart of claim 1, wherein the measuring element is selected from a cord, a rope, or a tape.

3. The digital growth chart of claim 1, wherein the system for automatically determining a person's height includes a magnet imbedded into the holder and a sensor that is attached to a microprocessor.

4. The digital growth chart of claim 1, wherein the system for automatically determining a person's height includes a series of markings on the measuring element and a sensor for determining a number of markings that pass the sensor.

5. The digital growth chart of claim 1, further comprising a speaker.

6. The digital growth chart of claim 1, further comprising a data storage unit.

7. The digital growth chart of claim 6, wherein the data storage unit may store data for a plurality of different individuals.

8. The digital growth chart of claim 1, wherein the holder includes a self-winding mechanism.

9. The digital growth chart of claim 1, further comprising a mechanism for causing a measurement to be taken.

10. The digital growth chart of claim 9, wherein the mechanism for causing a measurement to be taken is selected from a button or a switch.

11. The digital growth chart of claim 9, wherein the mechanism for causing a measurement to be taken is an automatic mechanism that takes the measurement after a period of time has elapsed.
